(19) United States
(12) Patent Application Publication
(10) Pub. No.: US 2006/0277589 A1
(43) Pub. Date: Dec. 7, 2006

(54) System And Method For Presenting High-Quality Video

(76) Inventors: Paul Anthony Margis, Irvine, CA (US); Long Bui, Aliso Vieju, CA (US); Thong Pham, Irvine, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/379,360

(22) Filed: Apr. 19, 2006

Related U.S. Application Data
(60) Provisional application No. 60/673,171, filed on Apr. 19, 2005.

(51) Int. Cl. H04N 7/173; H04N 7/16; G07G 1/00

(52) U.S. Cl. 725/135; 725/139; 235/100; 725/131

(57) ABSTRACT

A distribution system for vehicle information systems and methods for manufacturing and using same. The distribution system enhances the image quality of a conventional video display system via one or more video conversion systems. Each video conversion system receives information content via an incoming communication signal and enhances a video portion of the information content to form an enhanced video signal, which is provided to the video display system. By providing each video conversion system with a bypass system, the distribution system likewise can bypass one or more of the video conversion systems in the event of a distribution system failure such that communications among system resources can be maintained. As a result, passengers traveling aboard the vehicle can view information content with high resolution and high image quality during travel with limited interruption in service and without unwanted travel delays.

### CROSS-REFERENCE TO RELATED APPLICATIONS

This application claims priority to a U.S. Provisional patent application, Ser. No. 60/673,171, filed on Apr. 19, 2005. Priority to the provisional application is expressly claimed, and the disclosure of the provisional application is hereby incorporated herein by reference in its entirety.

### FIELD

The present invention relates generally to video conversion systems and more particularly, but not exclusively, to video distribution systems suitable for use with vehicle information systems installed aboard passenger vehicles.

### BACKGROUND

Passenger vehicles, such as automobiles and aircraft, often provide vehicle information systems, such as passenger entertainment systems, to satisfy passenger demand for entertainment and other information content during travel.

Conventional vehicle information systems include content presentation systems for presenting viewing content to the passengers. These vehicle information systems typically include video presentation systems, such as overhead cabin display systems and/or seatback display systems, and audio presentation systems, such as overhead speaker systems and/or individual headphones, for presenting the viewing content. The viewing content can include audio and video content that are derived from a variety of sources. Prerecorded viewing content, such as motion pictures and music, can be provided by internal content sources, such as audio and video players, that are installed aboard the vehicle. The conventional vehicle information systems likewise can include an antenna system for receiving viewing content, such as live television programming, transmitted from one or more external content providers (or sources) remote from the vehicle.

Such conventional vehicle information systems, however, suffer from many disadvantages. For example, these vehicle information systems typically include video presentation systems that are limited for use with composite video signals in an analog format. The video presentation systems therefore present the video content with low resolution and low image quality. The low resolution and low image quality associated with the use of composite video signals have proven to be a frequent source of passenger complaints. Further, once installed in the vehicle, the video presentation systems are difficult to remove and replace with higher-resolution video systems, complicating efforts to upgrade the vehicle information systems for improved image quality.

In view of the foregoing, a need exists for an improved video presentation system that overcomes the aforementioned obstacles and deficiencies of video presentation systems currently provided for use with vehicle information systems.

### BRIEF DESCRIPTION OF THE DRAWINGS

FIG. 1A is an exemplary top-level block diagram of an embodiment of a video conversion system for converting video information provided via an incoming communication signal into an enhanced video signal.

FIG. 1B is an exemplary top-level block diagram of an alternative embodiment of the video conversion system of FIG. 1A, wherein the video conversion system coverts the video information into at least one standard video signal.

FIG. 2 is an exemplary block diagram illustrating a preferred embodiment of video conversion system of FIGS. 1A-1B, wherein the video conversion system comprises a signal processing system.

FIG. 3A is an exemplary block diagram illustrating an alternative embodiment of the video conversion system of FIG. 2, wherein the video conversion system includes a bypass system for at least partially bypassing the signal processing system.

FIG. 3B is an exemplary block diagram illustrating another alternative embodiment of the video conversion system of FIG. 2, wherein the video conversion system includes a power system for providing power to at least one video display system.

FIG. 4A is an exemplary block diagram illustrating an embodiment of a vehicle information system, wherein the vehicle information system is installed aboard a passenger vehicle, such as an automobile.

FIG. 4B is an exemplary block diagram illustrating an alternative embodiment of the vehicle information system of FIG. 4A, wherein the vehicle information system is installed aboard an aircraft.

FIG. 5 is a detail drawing illustrating an exemplary passenger cabin of the passenger vehicle of FIGS. 4A-B, wherein the vehicle information system includes a plurality of passenger seats and at least one video display system.

FIG. 6 is a detail drawing illustrating a distribution system of the vehicle information system of FIGS. 4A-B, wherein the distribution system includes at least one video conversion system of FIG. 2 and distributes selected information content from at least one content source among the passenger seats.

FIG. 7A is an exemplary block diagram of an embodiment of the distribution system of FIG. 6, wherein the video conversion system distributes a video portion of the selected information content among a plurality of individually-controlled video display systems via composite video signals.

FIG. 7B is an exemplary block diagram of an alternative embodiment of the distribution system of FIG. 6, wherein the presentation of the composite video signals is controlled via a common control bus.

FIG. 7C is an exemplary block diagram of another alternative embodiment of the distribution system of FIG. 6, wherein the video conversion system provides the video portion of the selected information content to a video display system via a composite video signal and a component video signal.

FIG. 7D is an exemplary block diagram of still another alternative embodiment of the distribution system of FIG. 6, wherein the video conversion system provides the video portion of the selected information content to a video display system via a digital video input (DVI) signal.

It should be noted tat the figures are not drawn to scale and that elements of similar structures or functions are generally represented by like reference numerals for illustrative purposes throughout the figures. It also should be noted that the figures are only intended to facilitate the description of the preferred embodiments of the present invention. The figures do not describe every aspect of the present invention and do not limit the scope of the invention.

### DETAILED DESCRIPTION OF THE PREFERRED EMBODIMENTS

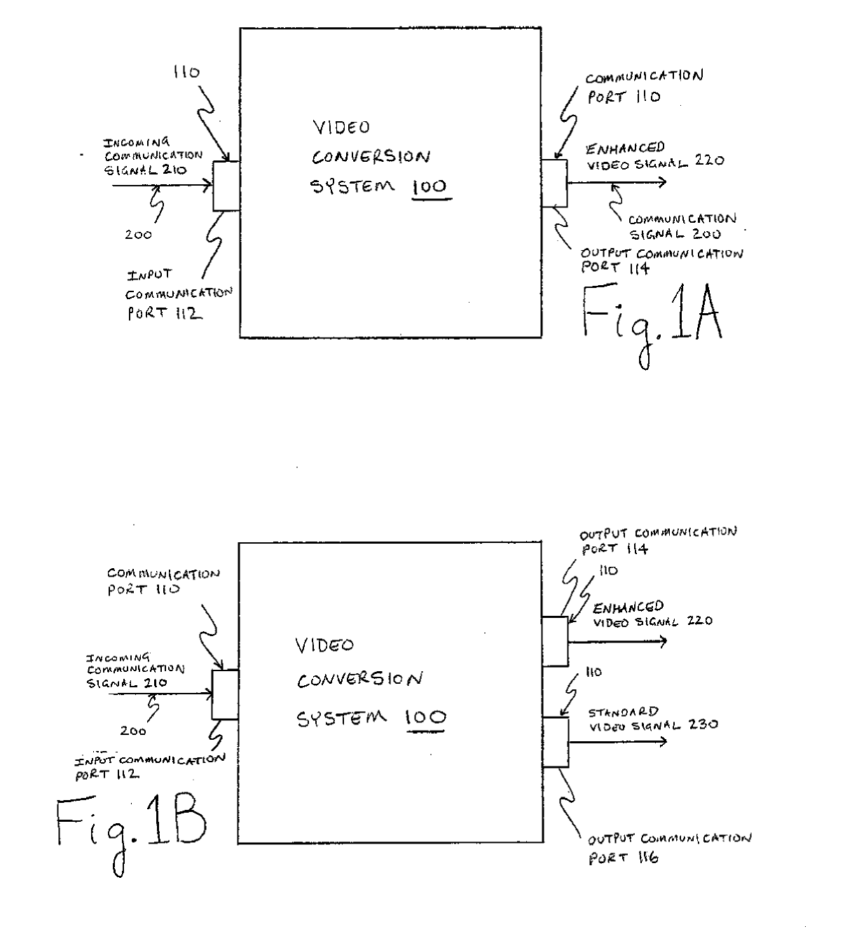

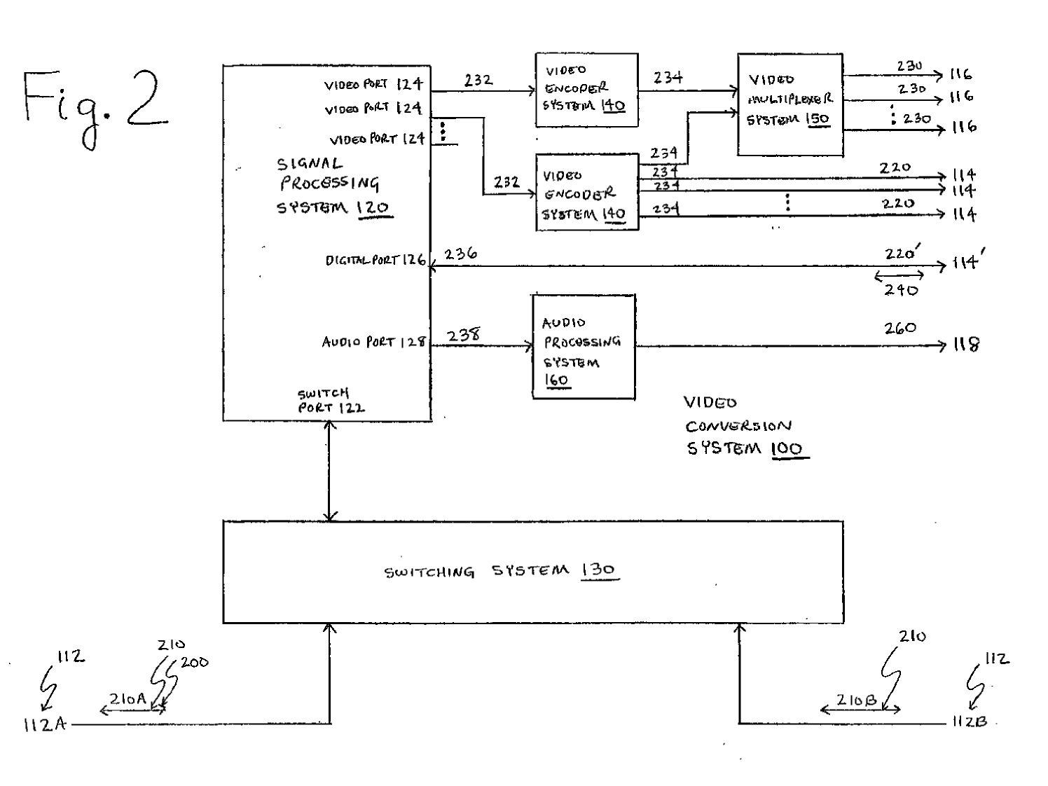

Since currently-used video presentation systems are limited to presenting composite video content with low resolution and low image quality, a video distribution system that includes a video conversion system for enhancing a video portion of selected information content can prove desirable and provide a basis for a wide range of video presentation applications, such as in vehicle information systems suitable for installation and use aboard automobiles, aircraft, and other types of passenger vehicles. This result can be achieved, according to one embodiment disclosed herein, by employing a video conversion system 100 as shown in FIGS. 1A-1B.

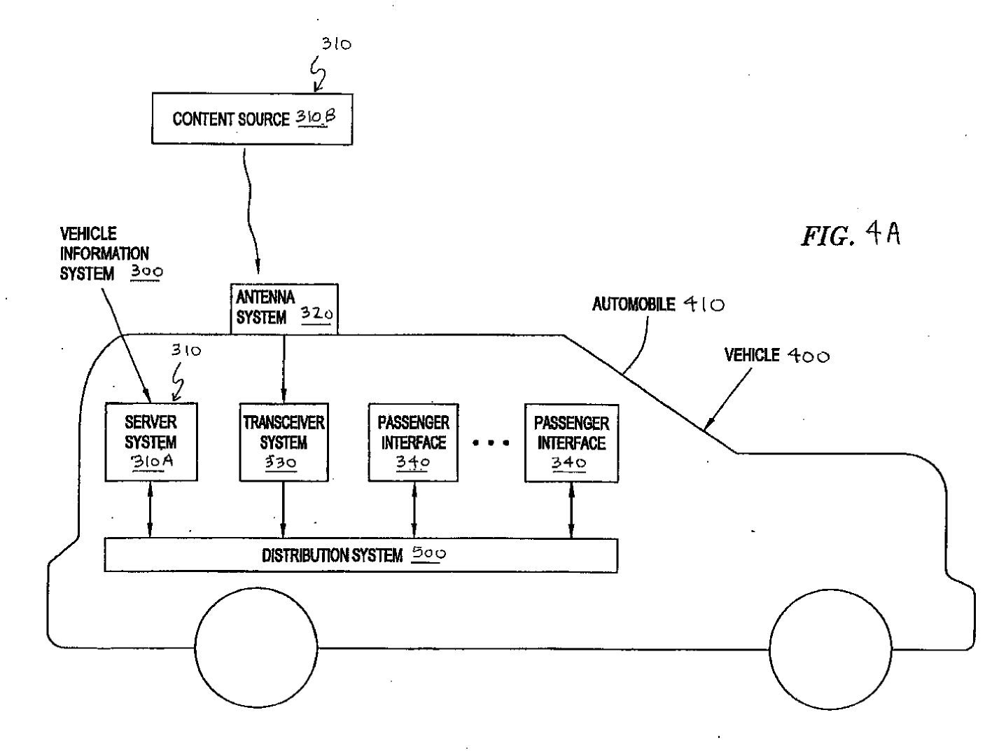

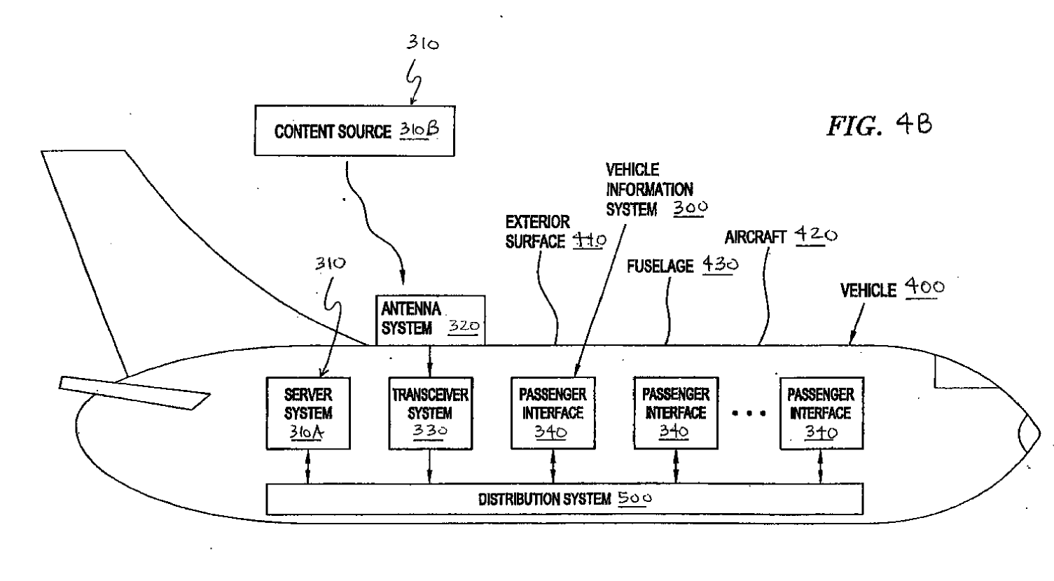

Turning to FIG. 1A, the video conversion system (or tapping unit) 100 for enhancing a video portion of selected information content is shown as having a plurality of communication ports 110, including at least one input communication port 112 and at least one output communication port 114, for exchanging communication signals 200. Each input communication port 112 can receive information content from a conventional content source 310 (shown in FIGS. 4A-B) via an incoming communication signal 210. As desired, the incoming communication signal 210 can include a predetermined number of signal channels (not shown) with multiple channels of the information content. Receiving the incoming communication signal 210, the video conversion system 100 can enhance a video portion of the information content to form an enhanced video signal 220, which can be distributed among at least one conventional video display system 342 (shown in FIG. 5) via one or more of the output communication ports 114 The video conversion system 100 thereby can enhance the image quality of the information content visually presented on the video display system 342.

The video conversion system 100 likewise can receive the incoming communication signal 210 and provide the video portion of the information content without enhancement as a standard video signal 230 as illustrated in FIG. 1B. The video conversion system 100 is shown as having at least one output communication ports 116 for providing the standard video signal 230. The standard video signal 230 thereby can be distributed among one or more of the video display systems 342 (shown in FIG. 5) in the manner discussed above. Thereby, the video conversion system 100 can selectably provide the enhanced video signal 220 to some of the video display systems 342 and the standard video signal 230 to other video display systems 342, as desired. Stated somewhat differently, a first channel of information content can be provided to a first set of video display systems 342 with enhanced image quality via the enhanced video signal 220; whereas, the information content from the first channel (and/or a second channel) can be provided to a second set of video display systems 342 with standard image quality via the standard video signal 230. The video conversion system 100 advantageously can enable the video display systems 342 to visually present the enhanced information content without requiring changes, such as upgrades or replacement, to the video display system 342 itself.

It will be appreciated that the communication signals 200 each can be provided with any conventional signaling type, format, and/or protocol suitable for transmission of video information. For example, the video conversion system 100 can be configured to receive the incoming communication signal 210 as an analog communication signal and/or a digital communication signal of any appropriate kind. Preferably being suitable for supporting high data transfer rates, the incoming communication signal 210 can comprise a high-speed Ethernet communication signal, such as any type of Fast Ethernet (such as 100Base-X and/or 100Base-T) communication signal and/or Gigabit (such as 1000Base-X and/or 1000Base-T) Ethernet communication signal, with a typical data transfer rate of at least approximately one hundred megabits per second (100 Mbps). Stated somewhat differently, the incoming communication signal 210 can be provided to the video conversion system 100 as a digital feed of Ethernet-supported video.

The video conversion system 100 likewise can provide the standard video signal 230 and/or the enhanced video signal 220 each with any conventional signaling type, format, and/or protocol. The standard video signal 230 and/or the enhanced video signal 220 can be provided as analog signals and/or digital signals, as desired. For example, the standard video signal 230 can comprise a traditional analog video signals, such as composite video signals; whereas, the enhanced video signal 220 can comprise video signals with high resolution and high image quality, such as video signals in any conventional high-definition video signal format. Exemplary enhanced video signals 220 that can be provided by the video conversion system 100 include analog component video signals and digital video input (DVI) signals, without limitation. The type, format, and/or protocol of the enhanced video signals 220 can be selected, for instance, based at least in part upon the capabilities of the relevant video display system 342.

As desired, one or more of the video display systems 342 likewise can include enhanced features to further increase the quality of the presentation of the information content with the standard image quality and/or the information content wit the enhanced image quality. The video display system 342, for instance, can include an advanced display system with a larger viewable area and/or higher image resolutions and advanced image processing functionality. The additional enhance features can include multi-screen format capability, as desired, for simultaneously presenting information content associated with two or more of the standard video signals 230 and/or the enhanced video signals 220. For example, the viewable area of the video display system 342 can be divided in any conventional manner, such as picture-in-picture (PiP) and/or picture-outside-picture (PoP), for simultaneously presenting two or more channels of the information content.

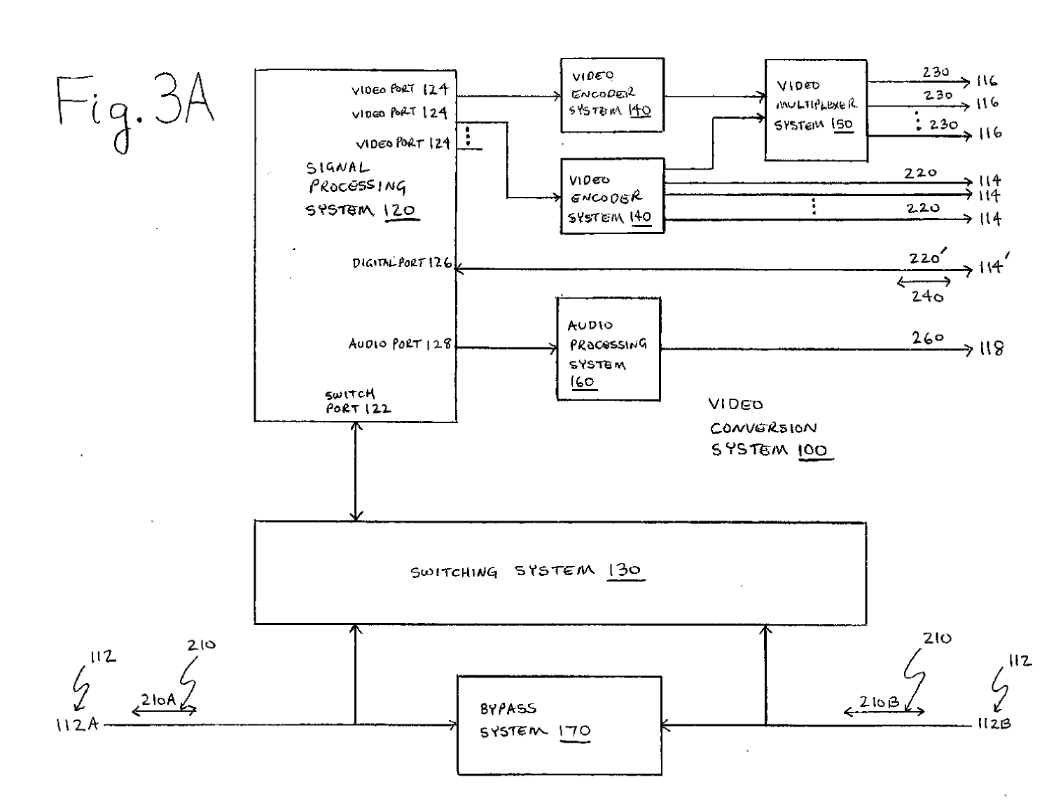

A preferred embodiment of the video conversion system 100 is illustrated in FIG. 2. In the manner discussed above with reference to FIGS. 1A-1B, the video conversion system 100 includes at least one input communication port 112 for receiving information content via the incoming communication signal 210 and one or more output communication ports 114, 116 for providing a video signal 220, 230. Each output communication port 114 provides the video portion of the enhanced information content as the enhanced video signal 230; whereas, each output communication port 116 provides the video portion of the information content without enhancement as the standard video signal 230.

As shown in FIG. 2, the video conversion system 100 can comprise a signal processing system 120 and a switching system 130. Being provided as a conventional signal processing system, the signal processing system 120 can comprise any appropriate number and type of conventional processing systems (not shown), such as one or more microprocessors (μPs), central processing units (CPUs), and/or digital signal processors (DSPs). The signal processing system 120 likewise can include a memory system (not shown) for storing and providing other conventional types of information, including instruction code, such as software or firmware, intermediate calculation results, and other information associated with the processing system. The memory system can comprise any conventional type of memory system, such as any suitable electronic, magnetic, and/or optical storage media, without limitation. Exemplary storage media can include one or more static random access memories (SRAMs), dynamic random access memories (DRAMs), synchronous dynamic random access memories (SDRAMs), electrically-erasable programmable read-only memories (EEPROMs), FLASH memories, hard drives (HDDs), compact disks (CDs), and/or digital video disks (DVDs) of any conventional kind.

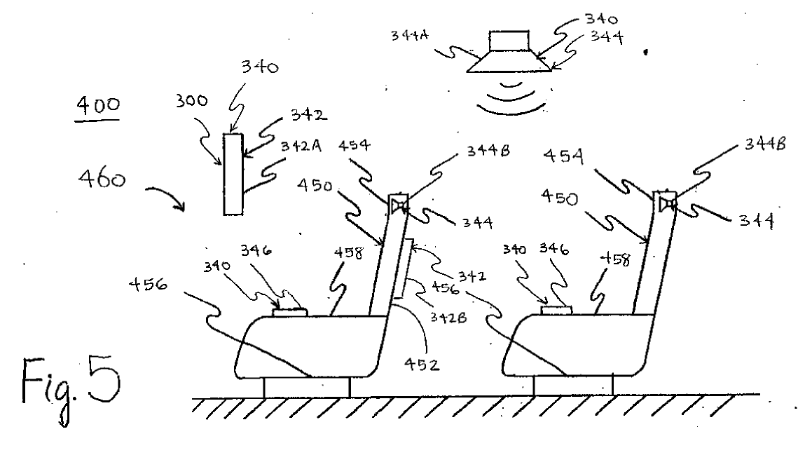

Operating under the control of the signal processing system 120, the switching system 130 can be provided as any conventional type of switching (or routing) system and preferably comprises a high-speed switching system suitable for supporting high-bandwidth communications. If configured to support communications in accordance with the Gigabit (such as 1000Base-X and/or 1000Base-T) Ethernet standard, for example, the switching system 130 can negotiate appropriate communication data rates, including ten, one hundred, or one thousand megabits per second (10/100/1000 Mbps), and/or a duplex mode, such as a half duplex mode and/or a full duplex mode, with each system resource 680 (shown in FIG. 6), such as each content source 310 (shown in FIGS. 4A-B) and/or the switching systems 130 of other video conversion systems 100, within a distribution system 500 (shown in FIG. 6).

Preferably supporting wired communications with each system resource 680 within its physical range, the switching system 130 can be configured to support wired and/or wireless communications with the system resources 680. For example, the switching system 130 can support wired communication via one or more copper connections and/or fiber optic connections. The fiber optic connections can be trunked, as desired. Illustrative switching systems 130 are set forth in the co-pending U.S. patent applications, entitled “SYSTEM AND METHOD FOR MANAGING CONTENT ON MOBILE PLATFORMS,” Ser. No. 11/123,327, filed on May 6, 2005; and entitled “SYSTEM AND METHOD FOR ROUTING COMMUNICATION SIGNALS VIA A DATA DISTRIBUTION NETWORK,” Ser. No. 11/277,896, filed on Mar. 29, 2006, which are assigned to the assignee of the present application and the respective disclosures of which are hereby incorporated herein by reference in their entireties.

Although shown and described as being coupled with, and being configured to communicate with, two input communication ports 112A, 112B with reference to FIG. 2 for purposes of illustration, the switching system 130 can be coupled with, and configured to communicate with, any suitable number and configuration of communication ports 110. Further, the communication ports 110 can be configured to support unidirectional communication and/or bi-directional communication of communication signals 200 among the switching system 130 and the system resources 680. Stated somewhat differently, the switching system 130 can transmit and/or receive communication signals 200 via each input communication port 112, including input communication ports 112A, 112B, without limitation.

For example, the input communication port 112A can be configured to receive an incoming communication signal 210A from content source 310A (shown in FIGS. 4A-B); whereas, the input communication port 112B can be configured to receive an incoming communication signal 210B from content source 310B (shown in FIGS. 4A-B). The incoming communication signals 210A, 210B likewise may provide different channels of information content, each being provided by a common content source 310A (shown in FIGS. 4A-B). As desired, the incoming communication signal 210A received via the input communication port 112A can be provided to the communication port 112B via the switching system 130 as the communication signal 210B. In other words, if the input communication port 112A receives the incoming communication signal 210A from content source 310A as set forth above, the switching system 130 can route the incoming communication signal 210A to the communication port 112B. The switching system 130 thereby can enable the video conversion system 100 to distribute the incoming communication signal 210A to one or more other video conversion systems 100.

The switching system 130 likewise can provide the incoming communication signal 210A, 210B to a switch port 122 of the signal processing system 120 as illustrated in FIG. 2. Receiving the incoming communication signal 210A, 210B, the signal processing system 120 can process the incoming communication signal 210A, 210B to provide one or more standard video signal 230 and/or enhanced video signal 220. If the incoming communication signal 210A comprises an Ethernet signal, for example, the signal processing system 120 can enhance the video portion of the information content by decoding the incoming communication signal 210A to provide an enhanced baseband video signal. The signal processing system 120 likewise can convert the video portion of the information content into a standard baseband video signal. The enhanced baseband video signal can be provided to at least one of the output communication ports 114 as the enhanced video signal 220; whereas, the standard baseband video signal can be provided to at least one of the output communication ports 116 as the standard video signal 230. The video conversion system 100 thereby can provide the enhanced video signal 220 and/or the standard video signal 230 for presentation via one or more of the video display systems 342 (shown in FIG. 5).

As shown in FIG. 2, the signal processing system 120 can include at least one video port 124 for providing an intermediate video signal 232 for conversion into the enhanced video signal 220 and/or the standard video signal 230. Each video port 124 is coupled with, and configured to communicate with a video encoder system 140 for encoding the intermediate video signal 232. The video encoder system 140 can receive the intermediate video signal 232 from the relevant video port 124 and encode the received intermediate video signal 232 to provide an encoded intermediate video signal 234. Comprising a conventional video encoder system, the video encoder system 140 can encode the received intermediate video signal 232 and provide the encoded intermediate video signal 234 in any conventional manner.

A plurality of the video encoder systems 140, in turn, is illustrated as being coupled with, and configured to communicate with, a video multiplexer system 150 for multiplexing the associated encoded intermediate video signals 234. The video multiplexer system 150 can receive the encoded intermediate video signal 234 from each relevant video encoder system 140 and multiplex the received encoded intermediate video signals 234 to provide the standard video signal 230. The video multiplexer system 150 can comprise a conventional video multiplexer system and can multiplex the plurality of received encoded intermediate video signals 234 to provide the standard video signal 230 in any conventional manner. As discussed above, the standard video signal 230 can be provided as a composite video signal and is provided to a relevant output communication port 116 for distribution among one or more of the video display systems 342 (shown in FIG. 5).

The video multiplexer system 150 can receive encoded intermediate video signal 234 from any predetermined number of video encoder systems 140; whereas, each video encoder system 140 likewise can provide its associated encoded intermediate video signal 234 to any suitable number of video multiplexer systems 150. Further, one or more video encoder system 140 can provide its associated encoded intermediate video signal 234 to a selected output communication port 114 as the enhanced video signal 220. The encoded intermediate video signal 234, for example, can be provided to the selected output communication port 114 as a component video signal. The selected output communication port 114 thereby can provide the enhanced video signal 220 for distribution among one or more video display system 342 as set forth above.

In the manner discussed above, the signal processing system 120 can enhance the video portion of the information content to provide any conventional type of enhanced video signal. As shown in FIG. 2, for example, the signal processing system 120 can convert the video portion of the information content into an intermediate video signal 236 in a digital format. The signal processing system 120 can include at least one digital port 126 for providing the intermediate video signal 236 to a digital output communication port 114′ as a digital enhanced video signal 220′. The digital port 126 and the digital output communication port 114′ can be directly coupled as illustrated in FIG. 2 and/or indirectly coupled via one or more intermediate systems in the manner set forth above with reference to the output communication ports 114, 116. The digital output communication port 114′ thereby can provide the digital enhanced video signal 220′ for distribution among one or more video display system 342 as set forth above.

The digital output communication port 114′ preferably comprises a conventional digital communication (or interface) bus, such as an MS-232 communication bus and/or an IEEE-488 communication bus, including serial communication busses and/or parallel communication busses. Thereby, the digital output communication port 114′ can support unidirectional communication and/or bi-directional communications between the signal processing system 120 and each associated video display system 342. By supporting bi-directional communications, the digital output communication port 114′ can not only provide the digital enhanced video signal 220′ for distribution among one or more video display system 342, but also exchange a control signal 240 between the signal processing system 120 and each associated video display systems 342. The digital output communication port 114′ thereby can provide a digital control interface for controlling each of the video display systems 342. The video conversion system 100 can control the video display systems 342 in any conventional manner, including by exchanging a control signal 240 with an individual video display system 342 and/or by exchanging a control signal 240 with an group of video display systems 342.

As desired, the video conversion system 100 likewise can enhance an audio portion of the selected information content. As illustrated in FIG. 2, the information content provided via the incoming communication signal 210A can include audio information. When the incoming communication signal 210A is provided to the signal processing system 120 in the manner set forth in more detail above, the signal processing system 120 can process the audio portion of the selected information content in any conventional manner to provide an intermediate audio signal 238. The signal processing system 120 can include at least one audio port 128 for providing the intermediate audio signal 238 to one or more audio output communication ports 118 as an enhanced audio signal 260. The enhanced audio signal 260 can comprise any conventional signaling type, format, and/or protocol suitable for transmission of audio information. As desired, the audio information can include any suitable number of audio channels. In other words, the audio information can be provided as monaural audio information and/or stereo audio information.

Although the audio port 128 and the audio output communication port 118 can be configured to communicate directly, the video conversion system 100 preferably includes an audio processing system 160 for converting the intermediate audio signal 238 into the enhanced audio signal 260. The audio port 128 is coupled with, and configured to communicate with the audio processing system 160. The audio processing system 160, in turn, can receive the intermediate audio signal 238 from the audio port 128 and provide the enhanced audio signal 260. Comprising a conventional audio processing system, such as an amplifier system and/or an audio filtering system, the audio processing system 160 can process the received intermediate audio signal 238 and provide the enhanced audio signal 260 in any conventional manner. In the manner discussed above with reference to the video output communication ports 114, 116, the audio output communication port 118 can provide the enhanced audio signal 260 for distribution among one or more audio presentation system 344 (shown in FIG. 5). As desired, the audio output communication port 118 likewise can provide the enhanced audio signal 260 to any of the video display systems 342 that include audio capabilities.

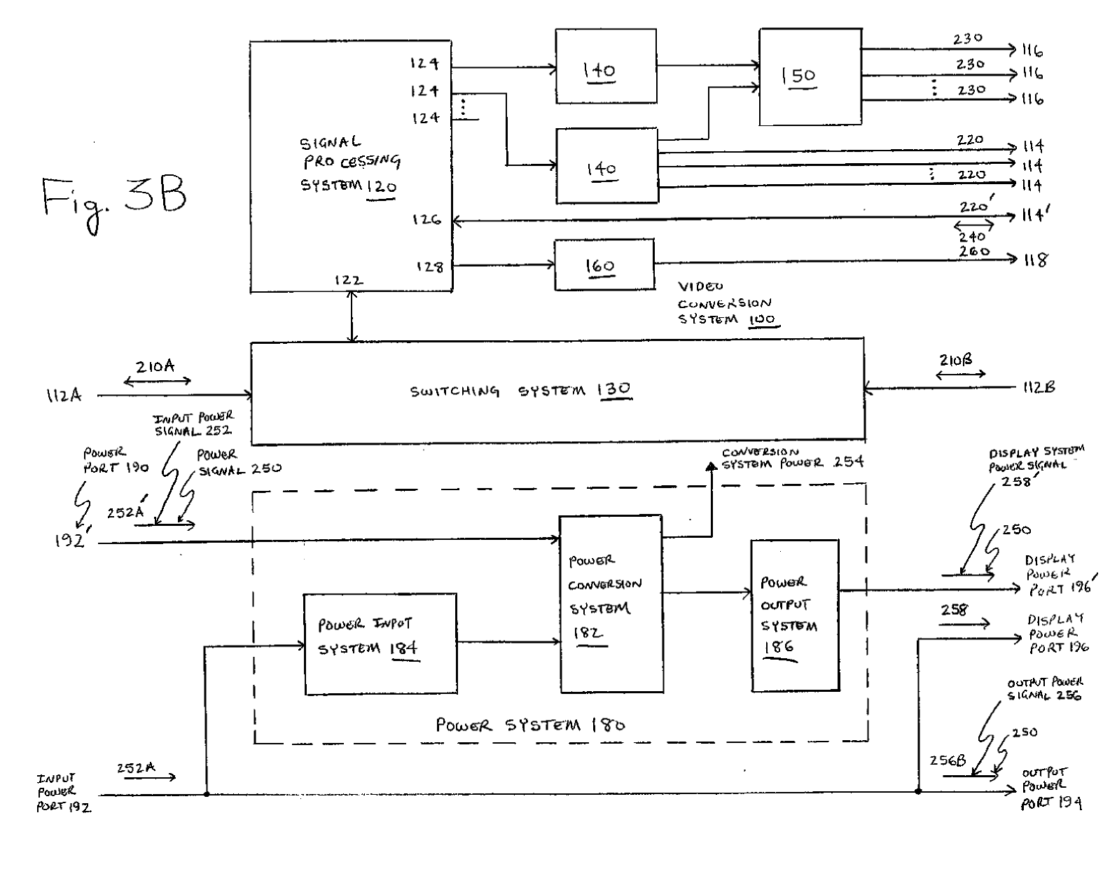

Turning to FIG. 3A, the video conversion system 100 preferably includes at least one bypass system 170 for at least partially bypassing the switching system 130 and, therefore, the signal processing system 120. The bypass system 170 can be provided in any conventional manner and preferably is provided in the manner set forth in the above-referenced co-pending U.S. patent application, entitled “SYSTEM AND METHOD FOR ROUTING COMMUNICATION SIGNALS VIA A DATA DISTRIBUTION NETWORK,” Ser. No. 11/277,896, filed on Mar. 29, 2006. The bypass system 170 advantageously permits the video conversion system 100 to support the exchange of communication signals 210A, 210B among selected input communication ports 112A, 112B even if a conversion system component, such as the signal processing system 120 and/or the switching system 130, of the video conversion system 100 fails. In other words, the bypass system 170 provides the video conversion system 100 with a source of redundancy to help ensure reliable communications.

The bypass system 170 can operate under the control of the signal processing system 120 in the manner discussed in more detail above with reference to FIG. 2. Being transparent to system operations when the video conversion system 100 is in a normal operation mode, the bypass system 170 preferably is biased to automatically activate, coupling the selected input communication ports 112A, 112B if the video conversion system 100 enters a failure mode, such as a loss of conversion system power 254 (shown in FIG. 3B). Although shown and described with reference to FIG. 3A as comprising one bypass system 170 for selectably coupling a pair of input communication ports 112A, 112B for purposes of illustration only, the video conversion system 100 can include any suitable number of bypass systems 170, each being configured to support the exchange of communication signals 210 among any appropriate number of input communication ports 112. The bypass system 170 therefore enables the malfunctioning video conversion system 100 to be bypassed such that the input communication ports 112 can continue to exchange the communication signals 210 via the bypass system 170 and without any significant interruption in communications.

Turning to FIG. 3B, the video conversion system 100, alternatively, and/or in addition, can include a power system 180 for providing power signals 250 to selected system resources 680 (shown in FIG. 6), such as the video display systems 342 (shown in FIG. 5) and/or the audio presentation systems 344 (shown in FIG. 5). An exemplary power system 180 is set forth in the above-referenced co-pending U.S. patent application, entitled “SYSTEM AND METHOD FOR ROUTING COMMUNICATION SIGNALS VIA A DATA DISTRIBUTION NETWORK,” Ser. No. 11/277,896, filed on Mar. 29, 2006. The power system 180 of FIG. 3B is shown as having a plurality of power ports 190, including two or more input power ports 192, 192′ and at least one power output port 194, 196, 196′. Being provided in any conventional manner, the power system 180 can include any suitable number of input power ports 192, each being configured to receive an input power signal 252A, from a selected system resource 680, such as from another video conversion system 100. The input power signals 252A preferably comprise substantially uniform input power signals and can be provided with any appropriate voltage levels and/or current levels, including direct current (DC) voltages and/or alternating current (AC) voltages, as desired. If the video conversion system 100 supports Ethernet communications, the power system 180 likewise can include at least one input power ports 192′ for receiving an input power signal 252A′, such as a Power-over-Ethernet (PoE) signal, derived from the Ethernet signals.

The power system 180 can process the input power signals 252A, 252A′ in any suitable manner to provide at least one output power signal 256 via the power output port 194. Each output power signal 256 can be provided with any voltage levels and/or current levels, including direct current (DC) voltages and/or alternating current (AC) voltages, that are suitable for any system resource 680 that receives the output power signal 256 from the power system 180. The power output port 194 of the power system 180 can provide the output power signal 256 to one or more system resources 680. As desired, the power system 180 likewise can be configured to provide one or more internal voltages, such as conversion system power 254, for the various conversion system component, including the signal processing system 120, the switching system 130, and/or the bypass system 170 (shown in FIG. 3A), of the video conversion system 100 as illustrated in FIG. 3B.

As illustrated in FIG. 3B, for example, the input power ports 192 can be coupled with the output power port 194 such that the output power port 194 can provide the input power signal 252A as the output power signal 256 to the selected system resources 680. The power system 180 can include one or more display power ports 196 that are coupled with the input power ports 192. Each display power port 196 thereby can provide a display system power signal 258 to selected video display systems 342 and/or audio presentation systems 344, as desired. The power system 180 of FIG. 3B likewise can include a power conversion system 182 for receiving the input power signals 252 and for providing the conversion system power 254 and/or a display system power signal 258′.

The power conversion system 182 can comprise a conventional power conversion system, such as a voltage regulation system and/or a DC-to-DC conversion system, of any kind. Preferably, the power conversion system 182 is provided as a plurality of redundant power conversion sub-systems (not shown) such that the power conversion system 182 can reliably provide the conversion system power 254 and/or a display system power signal 258′ even if one of the power conversion sub-systems fails. Likewise, since the power system 180 receives the input power signals 252 from the plurality of selected system resources 680, the reliability of the power system 180 is further ensured because the power system 180 can continue to provide the conversion system power 254 and/or the display system power signal 258′ even if one of the selected system resources 680 fails.

The power conversion system 182 can be directly coupled and/or indirectly with the input power ports 192, 192′ and/or the display power ports 196′ as desired. As illustrated in FIG. 3B, for example, the power conversion system 182 can be coupled with the input power ports 192 via an power input system 184; whereas, an power output system 186 can couple the power conversion system 182 and the display power ports 196′. Receiving the input power signals 252 from the plurality of selected system resources 680, the power input system 184 can combine the input power signals 252 into a single input power signal suitable for the power conversion system 182 The power input system 184 likewise can provide conventional input voltage protection, such as overvoltage protection and electromagnetic interference (EMI) protection. For example, the power input system 184 can include feedback protection circuitry, such as a diode array, for inhibiting an input power signal 252 from one selected system resource 680 from being fed back to the other selected system resources 680.

Similarly, the power output system 186 can receive individual output voltages provided by each redundant power conversion sub-system of the power conversion system 182 and can combine the individual output voltages to form the display system power signals 256′, which are suitable for providing to other system resources 680, such as selected video display systems 342 and/or selected audio presentation systems 344. In the manner set forth above with reference to the power input system 184, the power output system 186 can provide conventional output voltage protection, such as overvoltage protection and electromagnetic interference (EMI) protection. The power output system 186 can include feedback protection circuitry, such as a diode array, for inhibiting an individual output voltage from one of the redundant power conversion sub-systems from being fed back to the other redundant power conversion sub-systems of the power conversion system 182. The power output system 186 likewise can protect the power conversion system 182 from being adversely affected by any failures experienced by the system resources 680 to which the display system power signals 256′ are supplied.

Although the video conversion system 100 may be used in conjunction with information systems that are disposed in fixed locations, such as buildings, the video conversion system 100 likewise can advantageously be applied in portable system applications. Turning to FIGS. 4A-B, for example, the video conversion system 100 can be applied in a vehicle information system 300 that can be configured for installation aboard a wide variety of vehicles 400. Exemplary types of vehicles can include an automobile 410 (shown in FIG. 4A), an aircraft 420 (shown in FIG. 4B), a bus, a recreational vehicle, a boat, and/or a locomotive, without limitation. If installed on an aircraft 420 as illustrated in FIG. 4B, for example, the vehicle information system 300 can comprise a conventional aircraft passenger in-flight entertainment system, such as the Series 2000, 3000, eFX, and/or eX2 in-flight entertainment system as manufactured by Panasonic Avionics Corporation (formerly known as Matsushita Avionics Systems Corporation) of Lake Forest, Calif.

As shown in FIGS. 4A-B, the vehicle information system 300 can present information content from one or more conventional content sources 310, including internal content sources, such as server system 310A, that are installed aboard the vehicle 400 and/or remote content sources 310B, that can be external from the vehicle 400. For example, the content source 310 can be provided in the manner set forth in the co-pending U.S. patent applications, entitled “SYSTEM AND METHOD FOR DOWNLOADING FILES,” Ser. No. 10/772,565, filed on Feb. 4, 2004; entitled “SYSTEM AND METHOD FOR MANAGING CONTENT ON MOBILE PLATFORMS,” Ser. No. 11/123,327, filed on May 6, 2005; entitled “PORTABLE MEDIA DEVICE AND METHOD FOR PRESENTING INFORMATION CONTENT DURING TRAVEL,” Ser. No. 11/154,749, filed on Jun. 15, 2005; and entitled “SYSTEM AND METHOD FOR RECEIVING BROADCAST CONTENT ON A MOBILE PLATFORM DURING INTERNATIONAL TRAVEL,” Ser. No. 11/269,378, filed on Nov. 7, 2005, which are assigned to the assignee of the present application and the respective disclosures of which are hereby incorporated herein by reference in their entireties.

The information content can comprise any suitable type of information content, such as stored (or time-delayed) information content and/or live (or real-time) information content, in the manner set forth in the above-referenced co-pending U.S. patent applications, entitled “SYSTEM AND METHOD FOR DOWNLOADING FILES,” Ser. No. 10/772,565, filed on Feb. 4, 2004; entitled “PORTABLE MEDIA DEVICE AND METHOD FOR PRESENTING INFORMATION CONTENT DURING TRAVEL,” Ser. No. 11/154,749, filed on Jun. 15, 2005; and entitled “SYSTEM AND METHOD FOR RECEIVING BROADCAST CONTENT ON A MOBILE PLATFORM DURING INTERNATIONAL TRAVEL,” Ser. No. 11/269,378, filed on Nov. 7, 2005. As desired, the information content can include geographical information in the manner set forth in U.S. Pat. No. 6,661,353, entitled “METHOD FOR DISPLAYING INTERACTIVE FLIGHT MAP INFORMATION,” which is assigned to the assignee of the present application and the disclosure of which is hereby incorporated herein by reference in its entirety. In addition to entertainment content, such as live satellite television programming and/or live satellite radio programming, the information content preferably can include two-way communications such as real-time Internet access and/or telecommunications in the manner set forth in U.S. Pat. No. 5,568,484, entitled “TELECOMMUNICATIONS SYSTEM AND METHOD FOR USE ON COMMERCIAL AIRCRAFT AND OTHER VEHICLES,” which is assigned to the assignee of the present application and the disclosure of which is hereby incorporated herein by reference in its entirety.

Being configured to receive the information content from the content sources 310, the vehicle information system 300 can communicate with the content sources 310 in any conventional manner, preferably via wireless communications. As shown in FIGS. 4A-B, for example, the vehicle information system 300 can include an antenna system 320 and a transceiver system 330 for receiving the information content from the remote content sources 310B. The antenna system 320 preferably is disposed outside the vehicle 400, such as an exterior surface 440 of a fuselage 430 of the aircraft 420. The vehicle information system 300 likewise can include at least one conventional server system 310A, such as an information system controller 312 for providing overall system control functions for the vehicle information systems 300 and/or at least one media (or file) server system for storing preprogrammed content and/or the received information content, as desired. The server system 310A can include, and/or communicate with, one or more conventional peripheral media storage systems (not shown), including optical media devices, such as a digital video disk (DVD) system and/or a compact disk (CD) system, and or magnetic media systems, such as a video cassette recorder (VCR) system and/or a hard disk drive (HDD) system, of any suitable kind, for storing preprogrammed content and/or the received information content.

One or more passenger interface systems 340 are provided for selecting preprogrammed content and/or the received information content and for presenting the selected preprogrammed content and/or information content. As desired, the passenger interface systems 340 can comprise conventional passenger interfaces and can be provided in the manner set forth in the above-referenced co-pending U.S. patent application, entitled “PORTABLE MEDIA DEVICE AND METHOD FOR PRESENTING INFORMATION CONTENT DURING TRAVEL,” Ser. No. 11/154,749, filed on Jun. 15, 2005, as well as in the manner set forth in the co-pending U.S. patent application, entitled “SYSTEM AND METHOD FOR PRESENTING HIGH-QUALITY VIDEO TO PASSENGERS ON A MOBILE PLATFORM,” Ser. No. 60/673,171, filed on Apr. 19, 2005, the disclosure of which is hereby incorporated herein by reference in its entirety.

The passenger interface systems 340 can be divided into two or more interface groups in accordance with any predetermined criteria. If the vehicle information system 300 is installed aboard the aircraft 420, for example, a first interface group can be associated with a first class section of the aircraft 420; whereas, a second interface group can be associated with a coach class section of the aircraft 420. Similarly, the first and second interface groups may be respectively associated with the crew and passengers of the aircraft 420. The functionality of the passenger interface systems 340 in the first interface group can differ from the functionality of the passenger interface systems 340 in the second interface group. For example, the passenger interface systems 340 associated the first class section of the aircraft 420 can access premium content that is not available to the passenger interface systems 340 associated the coach class section. The passenger interface systems 340 associated the coach class section likewise might require payment of a fee prior to permitting access to selected (or premium) information content; whereas, the passenger interface systems 340 associated the first class section may not require payment of the fee to access the information content.

FIG. 5 provides a view of a passenger cabin 460 of the vehicle 400, such as the automobile 410A (shown in FIG. 4A) and/or the aircraft 420 (shown in FIG. 4B), aboard which the vehicle information system 300 has been installed. In the manner disclosed in the above-referenced co-pending U.S. patent application, entitled “SYSTEM AND METHOD FOR DOWNLOADING FILES,” Ser. No. 10/772,565, filed on Feb. 4, 2004, the passenger cabin 460 can include a plurality of passenger seats 450 and at least one typical passenger interface system 340. Each passenger interface system 340 can include a video presentation system 342 for visually presenting the video portion of selected information content and/or audio presentation system 344 for audibly presenting the audio portion of the information content. As illustrated in FIG. 5, the video presentation system 342 can be provided as one or more overhead cabin display systems 342A and/or one or more seatback display systems 342B being disposed on a back surface 452 of selected passenger seats 450.

The audio presentation system 344 illustrated in FIG. 5 includes one or more overhead speaker systems 344A and/or one or more seat speaker systems disposed within the passenger seats 450. Within the passenger seats 450, the seat speaker systems can be provided in any suitable manner, including, for example, as a headrest speaker systems 344B provided within in a headrest 454 of selected passenger seats 450 and/or in a base-mounted speaker system (not shown) disposed within a base 456 of the passenger seat 450. The audio presentation system 344 likewise can include one or more audio communication ports 346, such as an audio output ports, for audibly presenting the information content via headphones (not shown). The audio communication ports 346 can be provided, for example, on an armrest 458 of the passenger seats 450 as shown in FIG. 5.

Presentation of the information content can be controlled in any conventional manner. The vehicle information system 300, for instance, can include at least one crew control panel (not shown) for providing centralized control of the presentation of the information content. The passenger interface systems 340 likewise provide individualized controls at the passenger seats 450. For example, the passenger controls can be disposed on the armrests 458 of the passenger seats 450, and/or the seatback display systems 342B can comprise touch screen display systems as desired. Passengers (not shown) who are traveling aboard the vehicle 400 thereby can selected and enjoy the preprogrammed content and/or the received information content during travel.

Returning to briefly FIGS. 4A-B, the antenna system 320 and the transceiver system 330 of the vehicle information system 300 is illustrated as communicating with the server system 310A and the passenger interface systems 340 via a distribution system 500. The distribution system 500 can be provided in any conventional maimer and is configured to support any conventional type of communications, including wired communications and/or wireless communications, as set forth in the above-referenced co-pending U.S. patent application, entitled “PORTABLE MEDIA DEVICE AND METHOD FOR PRESENTING INFORMATION CONTENT DURING TRAVEL,” Ser. No. 11/154,749, filed on Jun. 15, 2005.

The distribution system 500 likewise can be provided with any appropriate topology, protocol, and/or architecture. Comprising a geometric arrangement of the system resources 680, common network topologies include mesh, star, bus, ring, and daisy-chain network topologies. As desired, the topology of the distribution system 500 can comprise a hybrid of the common network topologies, such as a network tree topology. Network protocols define a common set of rules and signals by which the system resources 680 can communicate via the distribution system 500. Illustrative types of network protocols include Ethernet and Token-Ring network protocols; whereas, peer-to-peer and client/server network architectures are examples of typical network architectures. It will be appreciated that the network system types, topologies, protocols, and architectures identified above are merely exemplary and not exhaustive.

Preferably being distributed via high-speed data communications, the preprogrammed content and/or the received information content can be distributed throughout the vehicle information system 300 in any suitable manner, including in the manner set forth in the above-referenced co-pending U.S. patent application, entitled “SYSTEM AND METHOD FOR ROUTING COMMUNICATION SIGNALS VIA A DATA DISTRIBUTION NETWORK,” Ser. No. 11/277,896, filed on Mar. 29, 2006, and/or in the manner set forth in U.S. Pat. Nos. 5,596,647, 5,617,331, and 5,953,429, each entitled “INTEGRATED VIDEO AND AUDIO SIGNAL DISTRIBUTION SYSTEM AND METHOD FOR USE ON COMMERCIAL AIRCRAFT AND OTHER VEHICLES,” the disclosures of which are hereby incorporated herein by reference in their entireties.

An exemplary vehicle information system 300 is illustrated in FIG. 6. The vehicle information system 300 includes a headend system 350 and a plurality of passenger interface systems 340 (shown in FIGS. 4A-B) that are configured to communicate via a distribution system 600. The headend system 350 can have at least one content source 310, such as a server system 310A and/or an antenna system 320 and a transceiver system 330 each being provided in the manner set forth in more detail above. Although the distribution system 600 can be provided in any conventional manner as discussed above, the distribution system 600 as shown in FIG. 6 is provided in the manner set forth in the above-referenced co-pending U.S. patent application, entitled “SYSTEM AND METHOD FOR ROUTING COMMUNICATION SIGNALS VIA A DATA DISTRIBUTION NETWORK,” Ser. No. 11/277,896, filed on Mar. 29, 2006, and in the above-referenced U.S. Pat. Nos. 5,596,647, 5,617,331, and 5,953,429, each entitled “INTEGRATED VIDEO AND AUDIO SIGNAL DISTRIBUTION SYSTEM AND METHOD FOR USE ON COMMERCIAL AIRCRAFT AND OTHER VEHICLES.” The distribution system 600 thereby can be provided as a plurality of area distribution boxes (ADBs) 620, a plurality of floor disconnect boxes (PDBs) 630, and a plurality of seat electronics boxes (SEBS) (and/or premium seat electronics boxes (PSEBs)) 640 being configured to communicate via a plurality of communication connections 650.

As illustrated in FIG. 6, the distribution system 600 can include a switching system 610 for providing an interface between the distribution system 600 and the headend system 350. The switching system 610 can comprise a conventional switching system, such as an Ethernet switching system, and is configured to couple the headend system 350 with the area distribution boxes 620. Preferably, the switching system 610 is coupled with each of the area distribution boxes 620 via a communication connection 650.

As desired, the switching system 610 can be provided as a plurality of interconnected switching sub-systems (not shown). If the switching system 610 is provided as a plurality of interconnected switching sub-systems, each of the switching sub-systems likewise can be configured to communicate with each of the area distribution boxes 620 via a communication connection 650. Each of the area distribution boxes 620, in turn, is coupled with a plurality of floor disconnect boxes 630 via a plurality of communication connections 650. Although the area distribution boxes 620 and the associated floor disconnect boxes 630 can be coupled in any conventional configuration, the associated floor disconnect boxes 630 preferably are disposed in a star network topology about a central area distribution box 620 as illustrated in FIG. 6.

Each floor disconnect box 630 is coupled with, and services, a plurality of daisy-chains of seat electronics boxes 640. Although it will be noted that the number and specific configuration of the seat electronics boxes 640 may be varied from system to system, the floor disconnect box 630 are shown and described with reference to FIG. 6 as being coupled with, and servicing, two daisy-chains of seat electronics boxes 640 for purposes of illustration. Each of the daisy-chains of seat electronics boxes 640 likewise can include any suitable number of seat electronics boxes 640 and is illustrated in FIG. 6 as including two daisy-chained seat electronics boxes 640. The seat electronics boxes 640, in turn, are configured to communicate with the plurality of passenger interface systems 340 (shown in FIGS. 6A-B).

The floor disconnect boxes 630 advantageously can be provided as routing systems and/or interconnected in the manner set forth in the above-referenced co-pending U.S. patent application, entitled “SYSTEM AND METHOD FOR ROUTING COMMUNICATION SIGNALS VIA A DATA DISTRIBUTION NETWORK,” Ser. No. 11/277,896, filed on Mar. 29, 2006. As desired, the distribution system 600 can include at least one FDB internal port bypass connection 660 and/or at least one SUB loopback connection 670. Each FDB internal port bypass connection 660 is a communication connection that permits floor disconnect boxes 630 associated with different area distribution boxes 620 to directly communicate. Each SEB loopback connection 670 is a communication connection 650 that directly couples the last seat electronics box 640 in each daisy-chain of seat electronics boxes 640 for a selected floor disconnect box 630 as shown in FIG. 6. Each SEB loopback connection 670 therefore forms a loopback path among the daisy-chained seat electronics boxes 640 coupled with the relevant floor disconnect box 630.

The vehicle information system 300 of FIG. 6 further includes at least one video conversion system 100. Although shown and described with reference to FIG. 6 as being separate system resources 680 for purposes of illustration, each video conversion system 100 can be at least partially combined (or integrated) wit another system resource 680. For example, a selected video conversion system 100 can be integrated with a relevant area distribution box 620, floor disconnect box 630, seat electronics box 640, and/or premium seat electronics box (not shown). Area distribution box 620A is shown as being coupled with a daisy-chain arrangement of video conversion systems 100A, 100B. The area distribution box 620A thereby can provide the incoming communication signal 210AB to the input communication port 112A of the video conversion system 100B.

The communication port 112B of the video conversion system 100B, in turn, provides the incoming communication signal 210AB to the input communication port 112A of the video conversion system 100A. Each of the video conversion systems 100A, 100B thereby can provide a plurality of standard video signals 230 to each of a plurality of video display systems 342. The information content associated with each standard video signal 230 may be uniform and/or different among the standard video signal 230. In other words, the plurality of video display systems 342 may present the same video images (not shown) and/or different video images (not shown).

Similarly, area distribution box 620B is illustrated as being coupled with a daisy-chain arrangement of video conversion systems 100C, 100D. In the manner discussed above with reference to the area distribution box 620A, the area distribution box 620B can provide the incoming communication signal 210CD to the input communication port 112A of the video conversion system 100C. The communication port 112B of the video conversion system 100C, in turn, provides the incoming communication signal 210CD to the input communication port 112A of the video conversion system 100D. Thereby, each of the video conversion systems 100C, 100D is shown as providing a digital enhanced video signal 220 to a video display system 342 in the manner set forth above.

To illustrate that the video conversion systems 100 can be associated with any suitable system resource 680, a daisy-chain arrangement of video conversion systems 100E, 100F is shown as being coupled with, and configured to communicate with, seat electronics box 640A. As discussed above with reference to the area distribution box 620A, the seat electronics box 640A can provide the incoming communication signal 210EF to the input communication port 112A of the video conversion system 100E, and the communication port 112B of the video conversion system 100E can provide the incoming communication signal 210EF to the input communication port 112A of the video conversion system 100F. Each of the video conversion systems 100E, 100F thereby can provide a plurality of standard video signals 230 to each of a plurality of video display systems 342 as shown in FIG. 6. Although shown and described with reference to FIG. 6 as being provided in pairs of daisy-chained video conversion systems 100 for purposes of illustration, the vehicle information system 300 can include any number and configuration of the video conversion systems 100, which number and configuration may vary from system to system.

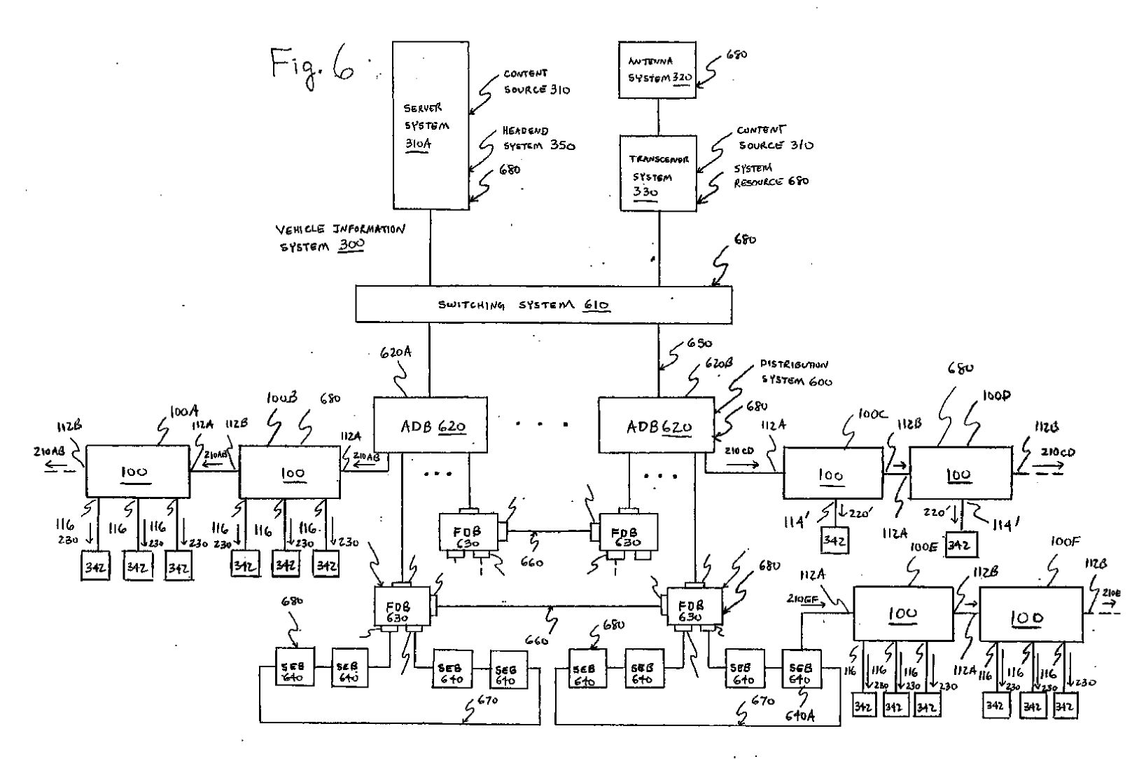

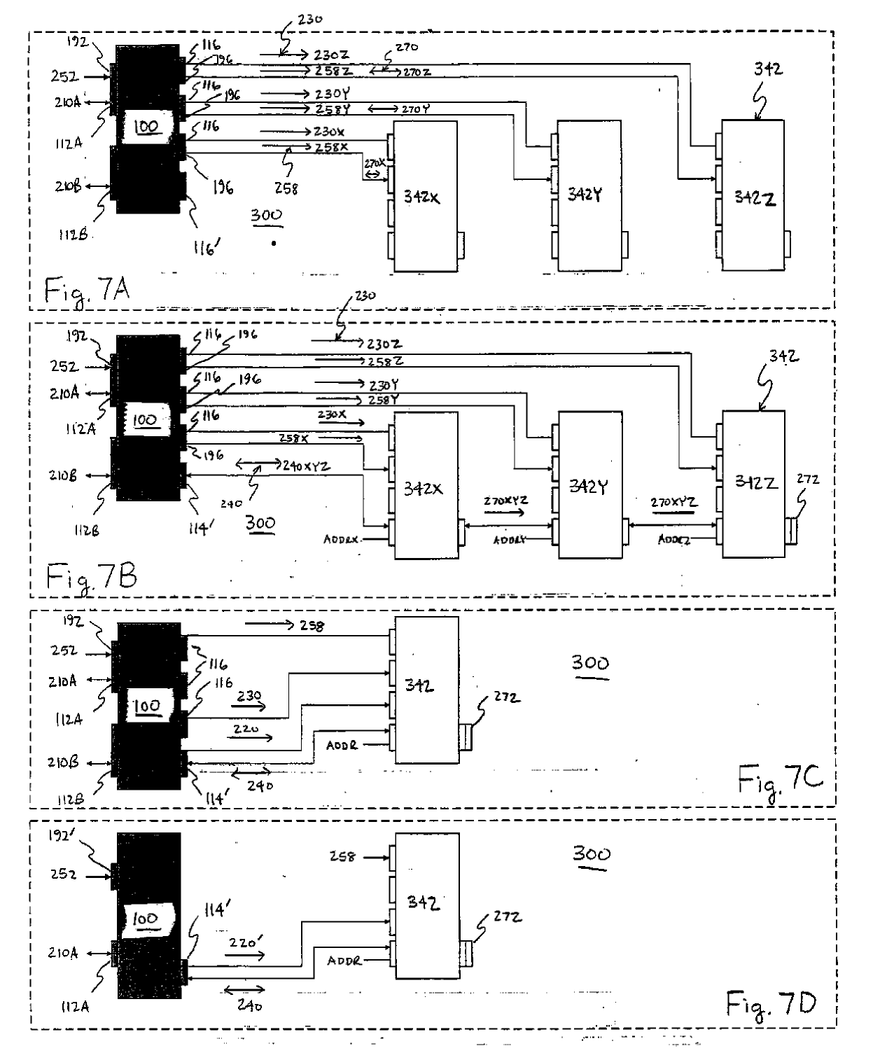

Exemplary operations of the video conversion system 100 within the vehicle information system 300 is illustrated in FIGS. 7A-D. The exemplary operations are shown and described are not exhaustive and are provided for purposes of illustration only, and not for purposes of limitation. Turning to FIG. 7A, for example, the video conversion system 100 is provided in the manner discussed in more detail above with reference to the video conversion system 100B (shown in FIG. 6). The video conversion system 100 can receive the incoming communication signal 210A from a selected system resource 680 (shown in FIG. 6), such as the area distribution box 620A (shown in FIG. 6), via the input communication port 112A. The output communication ports 116 of the video conversion system 100 are shown as being coupled with, and configured communicate with, video display systems 342X-Z. Thereby, the video conversion system 100 can provide standard video signals 230X-Z to the video display systems 342X-Z in the manner set forth above. As desired, the video conversion system 100 can provide the incoming communication signal 210A to another system resource 680, such as the video conversion system 100A (shown in FIG. 6), via the input communication port 112B as the communication signal 210B.

As discussed in more detail above with reference to FIG. 3B, the video conversion system 100 is shown as receiving an input power signal 252 via the input power port 192 and as providing display system power signals 258X-Z to the video display systems 342X-Z. Thereby, the video conversion system 100 can provide operating power to each of the video display systems 342X-Z. The video conversion system 100 likewise is illustrated in FIG. 7A as exchanging control signals 270X-Z with the video display systems 342X-Z in the manner set forth above with reference to the control signal 240 (shown in FIG. 2). For example, the signal processing system 120 (shown in FIG. 2) can exchange the control signals 270X-Z with the video display systems 342X-Z to provide discrete control, such as power on and off, for the video display systems 342X-Z. In other words, the video conversion system 100 exchanges the separate control signals 270X-Z with each of the video display systems 342X-Z via discrete (or separate) conductors (or busses).

The video conversion system 100 shown in FIG. 7B likewise is provided in the manner discussed in more detail above with reference to the video conversion system 100B (shown in FIG. 6). The input communication port 112A of the video conversion system 100 can receive the incoming communication signal 210A from the selected system resource 680 (shown in FIG. 6); whereas, the output communication ports 116 of the video conversion system 100 are coupled with the video display systems 342X-Z. The video conversion system 100 thereby can provide the standard video signals 230X-Z to the video display systems 342X-Z and can provide the incoming communication signal 210A to another system resource 680 via the input communication port 112B in the manner set forth above. As shown in FIG. 7B, the video conversion system 100 likewise can receive the input power signal 252 and provide the display system power signals 258X-Z to the video display systems 342X-Z.

FIG. 7B illustrates the video conversion system 100 as exchanging a common control signal 240XYZ with each of the video display systems 342X-Z as discussed above with reference to the control signal 240 (shown in FIG. 2). As shown in FIG. 7B, the digital output communication port 114′ is configured as a conventional digital communication (or interface) bus for exchanging the common control signal 240XYZ with the video display systems 342X-Z. The video display systems 342X-Z are coupled with the digital output communication port 114′ in a daisy-chain configuration such that the common control signal 240XYZ propagates through the video display systems 342X-Z. The video display system 342Z is the last video display system 342 in the daisy-chain and can, if necessary, include a conventional line terminator system 272.

Each video display systems 342X-Z is associated with a predetermined address ADDRX-Z, and the common control signal 240XYZ can be encoded with the address information to associate the common control signal 240XYZ with one or more relevant video display systems 342X-Z. If the video conversion system 100 transmits the common control signal 240XYZ for the video display system 342Y, for example, the video conversion system 100 can encode the common control signal 240XYZ with the address ADDRY of the video display system 342Y. Therefore, upon receiving the common control signal 240XYZ, the video display system 342X can ignore the common control signal 240XYZ because the address ADDRY does not match the address ADDRX of the video display system 342X.

The video display system 342X, in turn, provides the common control signal 240XYZ to the video display system 342Y. Since the address ADDRY encoded with the common control signal 240XYZ matches the address ADDRY of the video display system 342Y, the video display system 342Y can process the common control signal 240XYZ. The video display system 342Y likewise will provide the common control signal 240XYZ to the video display system 342Z, which can ignore the common control signal 240XYZ because the address ADDRY does not match the address ADDRZ of the video display system 342Z. The video display systems 342X-Z likewise can encode address information in the common control signal 240XYZ transmitted to the video conversion system 100.

Turning to FIG. 7C, the video conversion system 100 is shown as providing a standard video signals 230 and an enhanced video signal 220 to the video display system 342. In the manner discussed above with reference to FIGS. 7A-B, the video conversion system 100 can receive the incoming communication signal 210A from the selected system resource 680 (shown in FIG. 6) and can provide the incoming communication signal 210A to another system resource 680 via the input communication port 112B. The video conversion system 100 can receive the input power signal 252 and provide the display system power signals 258 to the video display system 342 as discussed above. With the video display system 342 shown as being associated with a predetermined address ADDR, the video conversion system 100 likewise can exchange a control signal 240 with the video display system 342 via the digital output communication port 114′ in the manner set forth in more detail above with reference to the common control signal 240XYZ (shown in FIG. 7B).

The video conversion system 100 of FIG. 7C provides the illustrated video display system 342 with a standard video signal 230 via an output communication port 116 and/or with an enhanced video signal 220 via an output communication port 114. Therefore, the video conversion system 100 can encode a control signal 240 with the address ADDR to instruct the video display system 342, for example, to display the information content associated with the standard video signal 230 and/or the information content associated with the enhanced video signal 220. The video display system 342 can receive and process the control signal 240 such that the selected information content is properly displayed.

FIG. 7D shows a video conversion system 100 that can receive the incoming communication signal 210A from the selected system resource 680 (shown in FIG. 6) and that can provide a digital enhanced video signal 220′ to the video display system 342. The video conversion system 100 can provide the digital enhanced video signal 220′ via the digital output communication port 114′ in the manner discussed in more detail above with reference to FIG. 2. With the video display system 342 shown as being associated with a predetermined address ADDR, the video conversion system 100 likewise can exchange a control signal 240 with the video display system 342 via the digital output communication port 114′ as discussed above with reference to the control signal 240 (shown in FIG. 7C).

The invention is susceptible to various modifications and alternative forms, and specific examples thereof have been shown by way of example in the drawings and are herein described in detail. It should be understood, however, that the invention is not to be limited to the particular forms or methods disclosed, but to the contrary, the invention is to cover all modifications, equivalents, and alternatives.

What is claimed is:

1. A video conversion system for enhancing a video portion of selected information content, comprising:
a plurality of communication ports, including:
an input communication port for receiving the selected information content via an incoming communication signal;
a first output communication port for providing the incoming communication signal to an external system resource;
a second output communication port for providing a standard video signal comprising the video portion of the selected information content in a standard video format; and
a third output communication port for providing an enhanced video signal comprising the video portion of the selected information content in an enhanced video format;
a signal processing system for receiving the incoming communication signal via said input communication port and for converting a video component of the incoming communication signal to provide at least one of the standard video signal and the enhanced video signal when said video conversion system is in a normal operation mode; and
a bypass system coupling said input communication port and said first output communication port and bypassing said signal processing system if said video conversion system enters a failure mode.

2. The video conversion system of claim 1, wherein the incoming communication signal comprises a plurality of information content channels.

3. The video conversion system of claim 1, wherein the incoming communication signal comprises an Ethernet signal is selected from the group of protocol standards consisting of Ethernet, Fast Ethernet, and Gigabit Ethernet.

4. The video conversion system of claim 1, wherein the standard video signal comprises a composite video signal.

5. The video conversion system of claim 1, wherein the enhanced video signal comprises a high-definition video signal.

6. The video conversion system of claim 5, wherein the enhanced video signal is selected from the group of high-definition signals consisting of component video signals and digital video input (DVI) signals.

7. The video conversion system of claim 1, wherein said signal processing system decodes the incoming communication signal to provide said at least one of the standard video signal and the enhanced video signal as a baseband video signal when said video conversion system is in said normal operation mode.

8. The video conversion system of claim 1, wherein said signal processing system converts the video component of the incoming communication signal to provide an intermediate video signal, and wherein said video conversion system further comprises a video encoder system for encoding the intermediate video signal to provide the enhanced video signal.

9. The video conversion system of claim 1, wherein said signal processing system converts the video component of the incoming communication signal to provide a plurality of intermediate video signals, and wherein said video conversion system further comprises a video encoder system for encoding each of the intermediate video signals to provide a plurality of encoded intermediate video signals and a video multiplexer system for multiplexing the plurality of encoded intermediate video signals to provide the standard video signal.

10. The video conversion system of claim 1, wherein said signal processing system converts an audio component of the incoming communication signal to provide an enhanced audio signal comprising an audio portion of the selected information content in an enhanced audio format, and wherein said plurality of communication ports further includes a fourth output communication port for providing the enhanced video signal.

11. The video conversion system of claim 10, wherein said signal processing system converts the audio component of the incoming communication signal to provide an intermediate audio signal, and wherein said video conversion system further comprises an audio processing system for converting the intermediate audio signal into the enhanced audio signal.

12. The video conversion system of claim 1, wherein said video conversion system further comprises a switching system, wherein said signal processing system receives the incoming communication signal from said input communication port via said switching system.

13. The video conversion system of claim 12, wherein said switching system comprises a high-speed Ethernet switching system.

14. The video conversion system of claim 12, wherein said switching system supports a communication protocol type selected from the group of protocol standards consisting of Ethernet, Fast Ethernet, and Gigabit Ethernet.

15. The video conversion system of claim 1, wherein said bypass system directly couples said input communication port and said first output communication port if said video conversion system enters said failure mode.

16. The video conversion system of claim 1, wherein said bypass system comprises an electronic relay system.

17. The video conversion system of claim 1, further comprising a power system for providing power to at least one video conversion system component, including said signal processing system and said bypass system.

18. The video conversion system of claim 17, wherein said power system provides power to at least one system resource.

19. The video conversion system of claim 18, wherein the at least one system resource includes a video display system.

20. The video conversion system of claim 17, wherein said power conversion system includes a plurality of redundant power conversion sub-systems.

21. The video conversion system of claim 1, wherein said power conversion system is disposed within a distribution system.

22. A distribution system for routing information content, comprising:
a plurality of system resources including a first system resource for providing selected information content via a communication signal and a second system resource for receiving the communication signal; and
a video conversion system, comprising:
a plurality of communication ports, including:
an input communication port for receiving the communication signal from said first system resource;
a first output communication port for providing the communication signal to said second system resource;
a second output communication port for providing a standard video signal comprising a video portion of the selected information content in a standard video format; and
a third output communication port for providing an enhanced video signal comprising the video portion of the selected information content in an enhanced video format;
a signal processing system for receiving the communication signal via said input communication port and for converting a video component of the communication signal to provide at least one of the standard video signal and the enhanced video signal when said video conversion system is in a normal operation mode; and
a bypass system coupling said input communication port and said first output communication port and bypassing said signal processing system if said video conversion system enters a failure mode.

23. The distribution system of claim 22, wherein said distribution system comprises a wired distribution system.

24. The distribution system of claim 23, wherein said wired distribution system includes at least one fiber optic communication connection.

25. The distribution system of claim 23, wherein said wired distribution system includes at least one copper communication connection.

26. The distribution system of claim 22, wherein said wired distribution system supports wired communications having a protocol type selected from the group of protocol standards consisting of Ethernet, Fast Ethernet, and Gigabit Ethernet.

27. The distribution system of claim 22, wherein said bypass system directly couples at least two of said second communication ports.

28. The distribution system of claim 22, wherein said bypass system directly couples said input communication port and said first output communication port if said video conversion system enters said failure mode.

29. The distribution system of claim 22, wherein said failure mode is selected from the group of failure modes consisting of a loss of power to the video conversion system, a loss of power to a selected system resource, a broken communication connection, and a system resource failure.

30. The distribution system of claim 22, wherein said distribution system is disposed within a vehicle information system.

31. The distribution system of claim 30, wherein said distribution system is installed onboard an aircraft.

32. A vehicle information system, comprising:
a headend system for providing information content;
a distribution system, including:
an area distribution box for receiving selected information content from said headend system via a communication signal; and
a first video conversion system, comprising:
a plurality of communication ports, including:
an input communication port for receiving the communication signal from said area distribution box;
a first output communication port for providing the communication signal to a second video conversion system;
a second output communication port for providing a standard video signal comprising a video portion of the selected information content in a standard video format; and
a third output communication port for providing an enhanced video signal comprising the video portion of the selected information content in an enhanced video format;
a signal processing system for receiving the communication signal via said input communication port and converting a video component of the communication signal to provide at least one of the standard video signal and the enhanced video signal when said video conversion system is in a normal operation mode; and
a bypass system coupling said input communication port and said first output communication port and bypassing said signal processing system if said video conversion system enters a failure mode; and
a video display system for receiving at least one of the standard video signal and the enhanced video signal and for presenting the video portion of the selected information.

33. The vehicle information system of claim 32, wherein said headend system includes at least one content source selected from the group of content sources consisting of a server system, a media server system, an antenna system, and a transceiver system.

34. The vehicle information system of claim 32, wherein said distribution system further includes an interface switching system for interfacing said headend system with said first area distribution box.

35. The vehicle information system of claim 34, wherein said interface switching system comprises an Ethernet switching system.

36. The vehicle information system of claim 34, wherein said interface switching system is provided as a plurality of interconnected switching sub-systems.

37. The vehicle information system of claim 32, wherein said bypass system directly couples said input communication port and said first output communication port if said video conversion system enters said failure mode.

38. The vehicle information system of claim 32, wherein said first video conversion system and said second video conversion system are connected with said area distribution box in a daisy-chain configuration.

39. The vehicle information system of claim 32, wherein said vehicle information system comprises a passenger entertainment system.

40. The vehicle information system of claim 39, wherein said vehicle information system is disposed onboard an aircraft.

41. An aircraft, comprising:
a fuselage and a plurality of passengers seat arranged within the fuselage; and
a vehicle information system disposed within the fuselage and having a headend system for providing information content and a distribution system, said distribution system including:
an area distribution box for receiving selected information content from said headend system via a communication signal; and
a first video conversion system, comprising:
a plurality of communication ports, including:
an input communication port for receiving the communication signal from said area distribution box;
a first output communication port for providing the communication signal to a second video conversion system;
a second output communication port for providing a standard video signal comprising a video portion of the selected information content in a standard video format; and
a third output communication port for providing an enhanced video signal comprising the video portion of the selected information content in an enhanced video format;
a signal processing system for receiving the communication signal via said input communication port and converting a video component of the communication signal to provide at least one of the standard video signal and the enhanced video signal when said video conversion system is in a normal operation mode; and
a bypass system coupling said input communication port and said first output communication port and bypassing said signal processing system if said video conversion system enters a failure mode; and
a video display system for receiving at least one of the standard video signal and the enhanced video signal and for presenting the video portion of the selected information.

42. A method for enhancing a video portion of information content, comprising:
receiving selected information content via an incoming communication signal;
in a normal operation mode, converting a video component of the incoming communication signal via a signal processing system to provide at least one of a standard video signal comprising the video portion of the selected information content in a standard video format and an enhanced video signal comprising the video portion of the selected information content in an enhanced video format; and
upon entering a failure mode,
bypassing said signal processing system; and
providing the incoming communication signal to an external system resource.

43. The method of claim 42, wherein said receiving selected information content comprises receiving selected information content as a plurality of information content channels.

44. The method of claim 42, wherein said receiving selected information content comprises receiving selected information content as an Ethernet signal selected from the group of protocol standards consisting of Ethernet, Fast Ethernet, and Gigabit Ethernet.

45. The method of claim 42, wherein said converting said video component of the incoming communication signal includes providing said standard video signal as a composite video signal.

46. The method of claim 42, wherein said converting said video component of the incoming communication signal includes providing said enhanced video signal as a high-definition video signal.

47. The method of claim 46, wherein said converting said video component of the incoming communication signal includes providing said enhanced video signal wherein said enhanced video signal is selected from the group of high-definition signals consisting of component video signals and digital video input (DVD signals.

48. The method of claim 42, wherein said converting the video component of the incoming communication signal comprises decoding the incoming communication signal to provide said at least one of the standard video signal and the enhanced video signal as a baseband video signal when said video conversion system is in said normal operation mode.

49. The method of claim 42, wherein said converting the video component of the incoming communication signal comprises converting the video component of the incoming communication signal to provide an intermediate video signal and encoding the intermediate video signal to provide the enhanced video signal.

50. The method of claim 42, wherein said converting the video component of the incoming communication signal comprises converting the video component of the incoming communication signal to provide a plurality of intermediate video signals, encoding each of the intermediate video signals to provide a plurality of encoded intermediate video signals, and multiplexing the plurality of encoded intermediate video signals to provide the standard video signal.

51. The method of claim 42, further comprising converting an audio component of the incoming communication signal to provide an enhanced audio signal comprising an audio portion of the selected information content in an enhanced audio format.

52. The method of claim 51, wherein said converting an audio component of the incoming communication signal includes converting the audio component of the incoming communication signal to provide an intermediate audio signal and converting the intermediate audio signal into the enhanced audio signal.

53. The method of claim 51, further comprising providing power to said signal processing system.

54. The method of claim 51, further comprising providing power to at least one system resource.

55. The method of claim 54, wherein said providing power to the at least one external system resource includes providing power to a video display system.
